(19) United States
(12) Patent Application Publication
(10) Pub. No.: US 2016/0031554 A1
(43) Pub. Date: Feb. 4, 2016

(54) CONTROL SYSTEM FOR AN AIRCRAFT

(71) Applicant: Siniger LLC, Long Beach, CA (US)

(72) Inventors: Maxim ESHKENAZY, Long Beach, CA (US); Eric Richard BARTSCH, Champaign, IL (US)

(21) Appl. No.: 14/814,009

(22) Filed: Jul. 30, 2015

Related U.S. Application Data
(60) Provisional application No. 61/999,523, filed on Jul. 30, 2014.

(51) Int. Cl. B64C 27/08; B64C 11/00; B64C 27/22

(52) U.S. Cl. CPC B64C 27/08; B64C 27/22; B64C 11/00

(57) ABSTRACT

An aircraft control system includes a vertical thrust system, a horizontal thrust system, and an aerodynamic system. The system further includes a controller in at least indirect communication with the vertical thrust system, the horizontal thrust system, and the aerodynamic system. The controller is configured to substantially simultaneously control, based on at least one of a single yaw input, a single pitch input, and a single roll input, the aerodynamic system and a differential thrust generated by the plurality of vertical thrust rotors of the vertical thrust system to adjust at least one of pitch, yaw, and roll of a vertical takeoff and landing aircraft in at least one of a plurality of flight stages. The controller is further configured to independently and substantially simultaneously control the vertical and horizontal thrust systems to generate vertical and horizontal thrust in at least one of the plurality of flight stages.

### CROSS-REFERENCE TO RELATED PATENT APPLICATIONS

This application claims priority to U.S. Provisional Patent Application No. 61/999,523, filed on Jul. 30, 2014, the entirety of which is incorporated by reference herein.

### FIELD

The present technology is generally related to aircraft control systems.

### BACKGROUND

Aircraft are widely used in a variety of applications including, for example, military, commercial, civil, experimental, entertainment, drones, and other general aviation applications. Conventional aircraft typically use a long runway to accelerate on the ground until the aircraft wings have attained sufficient lift to takeoff. Similarly, on landing, these aircraft use the runway to decelerate until the aircraft may be safely brought to a halt. In recent times, to avoid the need for large and costly runway infrastructure, vertical takeoff and landing (“VTOL”) aircraft have gained popularity. Taking off and landing vertically, instead of using the runway, requires the aircraft to provide both vertical and horizontal thrust. Thrust produced in the vertical direction provides lift to the aircraft during takeoff and landing, while thrust produced in the horizontal direction provides forward movement during flight.

### SUMMARY

In accordance with one aspect of the present disclosure, an aircraft control system is disclosed. The system includes a vertical thrust system having a plurality of vertical thrust rotors. Each of the plurality of vertical thrust rotors have an axis of rotation that is substantially perpendicular to a horizontal direction of flight. The system further includes a horizontal thrust system having at least one horizontal thrust rotor. The at least one horizontal thrust rotor has an axis of rotation that is substantially parallel to the horizontal direction of flight. The system further includes an aerodynamic system having a plurality of movable aerodynamic surfaces. The system further includes a controller in at least indirect communication with the vertical thrust system, the horizontal thrust system, and the aerodynamic system. The controller is configured to substantially simultaneously control, based on at least one of a single yaw input, a single pitch input, and a single roll input, the aerodynamic system and a differential thrust generated by the plurality of vertical thrust rotors of the vertical thrust system to adjust at least one of pitch, yaw, and roll of a vertical takeoff and landing aircraft in at least one of a plurality of flight stages of the vertical takeoff and landing aircraft. The controller is further configured to independently and substantially simultaneously control the vertical thrust system and the horizontal thrust system to generate vertical and horizontal thrust in at least one of the plurality of flight stages.

In accordance with another aspect of the present disclosure, a method for controlling flight of a vertical takeoff and landing aircraft is disclosed. The method includes receiving, at a controller located on the vertical takeoff and landing aircraft, input signals including a horizontal thrust input, a vertical thrust input, and at least one of a single yaw input, a single pitch input, and a single roll input from a pilot interface. The input signals cause the controller to perform steps including substantially simultaneously controlling, based on the at least one of the single yaw input, the single pitch input, and the single roll input, an aerodynamic system and a differential thrust generated by a plurality of vertical thrust rotors of a vertical thrust system. The controlling the differential thrust and the aerodynamic system adjusts at least one of pitch, yaw, and roll of the vertical takeoff and landing aircraft in at least one of a plurality of flight stages of the vertical takeoff and landing aircraft. The steps further include independently and substantially simultaneously controlling, based on the horizontal thrust input and the vertical thrust input, the vertical thrust system and a horizontal thrust system to generate vertical and horizontal thrust in at least one of the plurality of flight stages. The vertical thrust system includes the plurality of vertical thrust rotors. Each of the plurality of vertical thrust rotors has an axis of rotation that is substantially perpendicular to a horizontal direction of flight. The horizontal thrust system includes at least one horizontal thrust rotor. The at least one horizontal thrust rotor has an axis of rotation that is substantially parallel to the horizontal direction of flight. The aerodynamic system comprises a plurality of movable aerodynamic surfaces.

In accordance with yet another aspect of the present disclosure, a control system to control flight of a vertical takeoff and landing aircraft is disclosed. The control system includes a receiver located on the vertical takeoff and landing aircraft. The receiver is configured to receive input signals input by a pilot into a pilot interface. The control system further includes a vertical thrust system having a plurality of vertical thrust rotors. Each of the plurality of vertical thrust rotors have an axis of rotation that is substantially perpendicular to a horizontal direction of flight. The control system further includes a horizontal thrust system having at least one horizontal thrust rotor. The at least one horizontal thrust rotor has an axis of rotation that is substantially parallel to the horizontal direction of flight. The control system further includes an aerodynamic system having a plurality of movable aerodynamic surfaces. The control system further includes a controller configured to receive the input signals from the pilot interface via the receiver. The controller is in at least indirect communication with the vertical thrust system, the horizontal thrust system, and the aerodynamic system. The pilot interface is configured to receive the input signals including a horizontal thrust input, a vertical thrust input, a single yaw input, a single pitch input, and a single roll input. The controller is configured to, based on the input signals, simultaneously control the vertical thrust system and the aerodynamic system to control an attitude of the vertical takeoff and landing aircraft. The controller is further configured to, based on the input signals and substantially simultaneously with the control of the attitude, substantially simultaneously adjust the vertical thrust system and the horizontal thrust system. The horizontal thrust input and the vertical thrust input are configured to be input into the pilot interface independently.

### BRIEF DESCRIPTION OF THE DRAWINGS

FIG. 1 is an illustrative diagram of an aircraft, in accordance with at least some embodiments.

FIGS. 2a-d are illustrative diagrams of pilot interfaces used to input signals into the aircraft of FIG. 1 for controlling at least some aspects of flight of the aircraft, in accordance with at least some embodiments.

FIG. 3 is an illustrative diagram showing various flight stages of the aircraft of FIG. 1, in accordance with at least some embodiments.

FIG. 4 is an illustrative diagram showing control signals for controlling at least some aspects of flight of the aircraft of FIG. 1 in response to the input signals from the pilot interfaces of FIGS. 2a-d, in accordance with at least some embodiments.

FIG. 5 is an illustrative flowchart outlining operations for adjusting yaw of the aircraft of FIG. 1, in accordance with at least some embodiments.

FIG. 6 is an illustrative flowchart outlining operations for adjusting roll of the aircraft of FIG. 1, in accordance with at least some embodiments.

FIG. 7 is an illustrative flowchart outlining operations for adjusting pitch of the aircraft of FIG. 1, in accordance with at least some embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Provided is a control system for an aircraft having at least a vertical motion and a horizontal motion during flight. The control system includes a vertical thrust system, a horizontal thrust system, and an aerodynamic system. The control system also includes a receiver on board the aircraft to receive input signals from a pilot interface. The receiver routes the input signals received from the pilot interface to a controller, as well as to the horizontal thrust system and the aerodynamic system to adjust at least one of a pitch, yaw, and roll of the aircraft. Specifically, the disclosure use of the vertical thrust system and the aerodynamic system to simultaneously impact or control at least one of yaw, pitch, and roll of the aircraft, and provides for simultaneous and independent control to the thrust levels of the horizontal thrust system and the vertical thrust system.

By virtue of using the control system of the present disclosure, a pilot may maneuver the aircraft remotely in a safe, convenient, and efficient manner. Further, the control system may be used in all stages of flight of the aircraft, including, takeoff, landing, hover, transition and forward flight. Furthermore, the horizontal thrust system may be configured to generate thrust substantially simultaneously with and independently from the vertical thrust system, while the aerodynamic system and vertical thrust system are configured to operate simultaneously and in conjunction with each other, to allow the pilot to easily and safely transition the aircraft from the vertical motion to the horizontal motion, as well as transition the aircraft from the horizontal motion to the vertical motion.

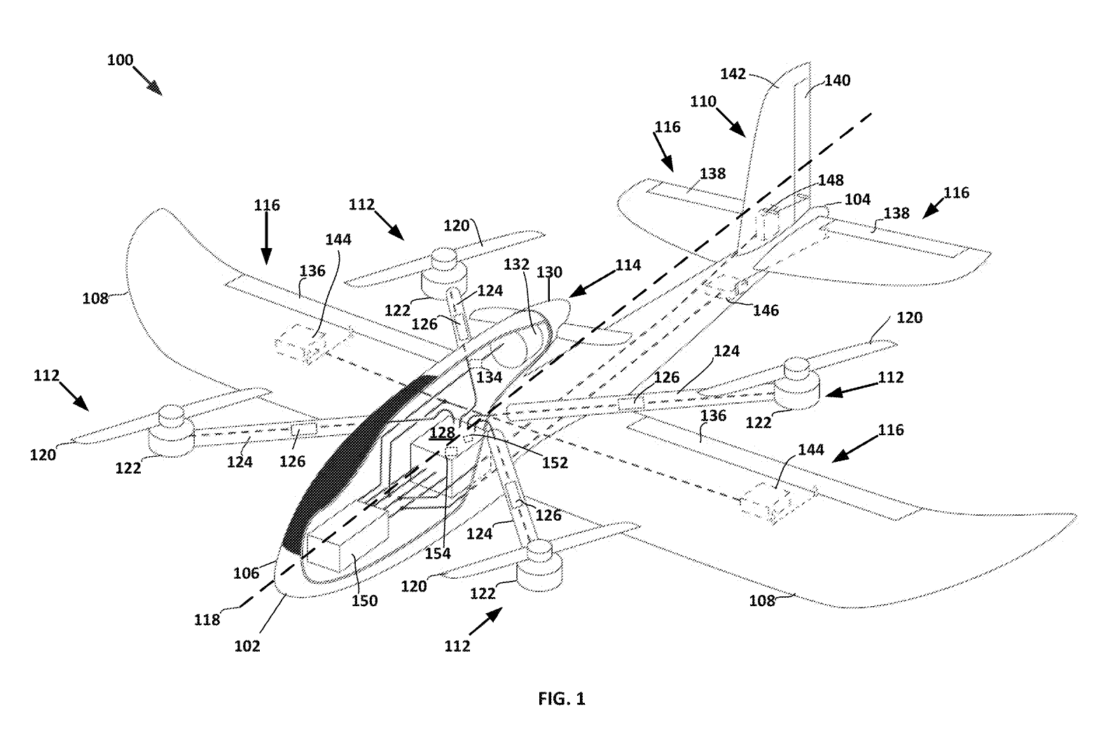

Referring now to FIG. 1, an illustrative diagram of an aircraft 100 is shown, in accordance with at least some embodiments of the present disclosure. The aircraft 100 is both a vertical takeoff and landing (“VTOL”) aircraft and a rotary wing aircraft. In other embodiments, the aircraft 100 may be any type of aircraft in which it is desirable to have at least some vertical motion, whether during takeoff, landing, or during flight, coupled with at least some horizontal motion. Furthermore, the aircraft 100 may be of any size or weight. For example, in at least some embodiments, the aircraft 100 may be a small aircraft having a total weight of less than five kilograms, a total length of less than half a meter from a nose 102 to an aft-most surface 104 of the aircraft, and a wingspan of less than half a meter. In other embodiments, the aircraft 100 may be a larger/heavier aircraft, potentially even capable of carrying passengers and cargo, or smaller/lighter than that described above. Additionally, the aircraft 100 may be a manned aircraft configured to carry one or more pilots on board, or alternatively, the aircraft may be an unmanned aircraft or drone configured to navigate either as a remotely piloted vehicle or autonomously under remote or programmed direction.

As shown, the aircraft 100 includes a fuselage 106 connected to wings 108 and empennage 110. Other components and systems not disclosed herein but that are commonly employed in the aircraft of the type described herein are contemplated and considered within the scope of the present disclosure. The aircraft 100 also includes a control system for controlling at least some aspects of flight of the aircraft 100. The control system includes a vertical thrust system 112, a horizontal thrust system 114, and an aerodynamic system 116. The vertical thrust system 112 is used to provide a vertical thrust to the aircraft 100 in a direction substantially perpendicular to a longitudinal axis 118 of the fuselage 106, while the horizontal thrust system 114 is used to provide a horizontal thrust to the aircraft in a direction substantially parallel to the longitudinal axis of the fuselage. The aerodynamic system 116, on the other hand, is used to control yaw, pitch, and roll during various flight stages, as discussed below; and is used in conjunction with the vertical thrust system 112 during flight stages when it is desirable for both systems to be active.

Additionally, various components of the vertical thrust system 112, the horizontal thrust system, 114, and the aerodynamic system 116 may be electrically actuated from an electric storage battery, electrically driven with energy provided from an onboard generator using liquid fuels, or driven by a piston or turbine aircraft engine. Other mechanisms to provide power to the components of the vertical thrust system 112, the horizontal thrust system, 114, and the aerodynamic system 116 may be used in other embodiments as well. Furthermore, as used herein, the vertical thrust system 112 may also be referred to as a multi lifting system, the horizontal thrust system 114 may be referred to as a forward thrust system or a propulsion system, and the aerodynamic system 116 may be referred to as a control surfaces system.

With respect to the vertical thrust system 112 in particular, in at least some embodiments, it may include vertical thrust rotors 120. For example and as shown, the vertical thrust system 112 includes four of the vertical thrust rotors 120, although in other embodiments, only three vertical thrust rotors may be used as well. In yet other embodiments, fewer than three or greater than four vertical thrust rotors may be used in the vertical thrust system 112. Furthermore, each of the vertical thrust rotors 120 may be positioned such that an axis of rotation of the vertical thrust rotors is substantially perpendicular to a horizontal direction of flight or, in other words, substantially perpendicular to the longitudinal axis 118. Moreover, in at least some embodiments, each of the vertical thrust rotors 120 may be of a similar size, shape, and weight, although in other embodiments, one or more of the vertical thrust rotors may have at least some parameters (e.g., size, shape, weight) that may vary from the parameters of the remaining ones of the vertical thrust rotors.

In at least some embodiments, the vertical thrust rotors 120 are fixed pitch rotors to decrease the number of moving parts and mechanical complexity of the vertical thrust system 112. In other embodiments, one or more of the vertical thrust rotors 120 may be variable pitch rotors. Furthermore, each of the vertical thrust rotors 120 may be configured to rotate in a clockwise direction or a counter-clock wise direction. In at least some embodiments, each of the vertical thrust rotors 120 may be configured to rotate in the same direction, whether clockwise or counter-clockwise. In other embodiments, some of the vertical thrust rotors 120 may be configured to rotate in a clockwise direction, while others may be configured to rotate in a counter-clockwise direction. Additionally, each of the vertical thrust rotors 120 have associated with it a vertical thrust motor 122, an arm extension 124, and a vertical thrust speed controller 126. The vertical thrust motor 122 is used to drive the vertical thrust rotors 120 with which the vertical thrust motor is associated. In at least some embodiments, the vertical thrust motor 122 is a brushless electric motor, although in other embodiments, one or more of the vertical thrust motors may be other types of motors deemed suitable for driving the vertical thrust rotors 120. Although FIG. 1 shows separate vertical thrust speed controllers 126 to control each of the vertical thrust motors 122, an alternative embodiment may have a single vertical thrust controller that is capable of separately controlling each of the vertical thrust motors 122 independently.

With respect to the arm extension 124, it is connected at least indirectly to one of the vertical thrust rotors 120 to extend that vertical thrust rotor to a sufficient distance away from the longitudinal axis 118, or in other words, away from the fuselage 106 of the aircraft 100. Thus, the arm extension 124 is used to space out the vertical thrust rotors 120 from one another. By virtue of spacing out the vertical thrust rotors 120, the vertical thrust rotors may avoid colliding and, therefore, damaging, one another. Spacing out the vertical thrust rotors 120 also improves efficiency of the vertical thrust rotors by substantially minimizing or possibly eliminating any disruption in thrust that may result from spacing the vertical thrust rotors too close to one another. To accomplish the advantages of sufficiently distancing the vertical thrust rotors 120 from one another, in at least some embodiments, the arm extension 124 of each of the vertical thrust rotors may be long enough such that the distance between the axis of rotation of any two of the vertical thrust rotors is at least one quarter of the wingspan of the wings 108. In at least some other embodiments, the arm extensions 124 may be long enough to separate the axes of rotation of at least four of the vertical thrust rotors 120 by a distance of at least twice a diameter of the one of the vertical thrust rotors being spaced by said arm extensions 124. Furthermore, in some embodiments, the arm extension 124 may be designed to vary the length and/or position of the arm extension dynamically when the aircraft is in motion, only when the flight is not moving, or the arm extension may be of a fixed length. In at least some embodiments, the arm extension 124 may not be needed, such as, when the vertical thrust rotors 120 are embedded within a frame of the wings 108

The arm extension 124, as well as the vertical thrust motor 122, are controlled by the vertical thrust speed controller 126 associated therewith. By controlling the vertical thrust motor 122 and the arm extension 124, the vertical thrust speed controller 126 controls the torque, and therefore, thrust, generated by the vertical thrust rotors 120 associated with that vertical thrust speed controller. Specifically, based upon the commands received by the vertical thrust speed controller 126 from a main controller 128, the vertical thrust speed controller varies the length and/or position of the arm extension 124 (e.g., when the length and/or position of the arm extension may be varied), as well as the speed of the vertical thrust motor 122 to vary the thrust of the vertical thrust rotors 120 and the yaw, pitch, and roll moments imparted to aircraft 100 by vertical thrust rotors 120. Since each of the vertical thrust rotors 120 is controlled by its own instance of the vertical thrust speed controller 126, in at least some embodiments, each of the vertical thrust rotors is independently controlled such that a different thrust may be commanded from each one of the vertical thrust rotors.

Thus, the vertical thrust system 112 includes the vertical thrust rotors 120. Each of the vertical thrust rotors 120 has associated with it one of the vertical thrust motors 122 to vary the torque of the vertical thrust rotors, the arm extension 124 to vary the distance of the vertical thrust rotors from the fuselage 106, and the vertical thrust speed controller 126 to control the vertical thrust motor and the arm extension to vary the thrust generated by the vertical thrust rotors.

Referring still to FIG. 1, the horizontal thrust system 114 includes a horizontal thrust rotor 130, a horizontal thrust motor 132, and a horizontal thrust speed controller 134. The horizontal thrust rotor 130 has an axis of rotation that is substantially parallel to the horizontal direction of flight, or in other words, substantially parallel to the longitudinal axis 118. Thus, the horizontal thrust rotor 130 has an axis of rotation that is substantially perpendicular to the axis of rotation of the vertical thrust rotors 120. Furthermore, in at least some embodiments, but not always, the shape and diameter of the horizontal thrust rotor 130 may be different than the shape and diameter of the vertical thrust rotors 120 to optimize the thrust provided by each type of rotor when considering the relatively slow airspeed of the aircraft 100 while the vertical thrust rotors 120 are supporting it in hovering flight, and the relatively high airspeed of the aircraft 100 while the horizontal thrust rotor 130 is propelling it in high speed forward flight. Additionally, although only one horizontal thrust rotor 130 is shown and described herein, in at least some embodiments, additional ones of the horizontal thrust rotor may be employed, particularly depending upon the size and weight of the aircraft 100, and the horizontal thrust desired to be generated.

Also, like the vertical thrust rotors 120, the torque and, therefore, the thrust generated by the horizontal thrust rotor 130 is at least partially controlled by the horizontal thrust motor 132 under control of the horizontal thrust speed controller 134. Specifically, upon receiving an instruction to vary the thrust generated by the horizontal thrust rotor 130, the horizontal thrust speed controller 134 varies the speed of the horizontal thrust motor 132, which in turn varies the torque and, therefore, the thrust generated by the horizontal thrust rotor. In at least some embodiments and again similar to the vertical thrust motor 122, the horizontal thrust motor 132 is a brushless electric motor, although other types of motors may be used as well. Likewise, in at least some embodiments, the horizontal thrust rotor 130 may have fixed pitch blades, although in other embodiments, the horizontal thrust rotor may have variable pitch blades. Furthermore, the horizontal thrust rotor 130 may be configured to rotate either in a clockwise or a counter-clockwise direction.

By virtue of associating the horizontal thrust rotor 130 with its own one of the horizontal thrust motor 132, as well as by associating each of the vertical thrust rotors 120 with its own vertical thrust motor 122, the horizontal thrust rotor and each of the vertical thrust rotors are controlled independently. As a result of controlling the horizontal thrust rotor 130 and each of the vertical thrust rotors 120 independently, the horizontal thrust system 114 generates thrust independently from and substantially simultaneously with the vertical thrust system 112. The aerodynamic system and the vertical thrust system are controlled simultaneously and non-independently to impart roll, pitch, and yaw moments to aircraft 100 as it gains forward speed. As will be discussed below, such independent and substantially simultaneous generation of thrust of the vertical thrust rotors 120 and the horizontal thrust rotor 130, combined with simultaneous and non-independent actuation of the vertical thrust system and the aerodynamic system, facilitates easier and more efficient transition of the aircraft 100 from a vertical motion to a horizontal motion and from the horizontal motion to the vertical motion.

In addition to the vertical thrust system 112 and the horizontal thrust system 114, the control system of the aircraft 100 also includes the aerodynamic system 116. The aerodynamic system 116 includes a plurality of aerodynamic surfaces including an aileron 136 on each of the wings 108, elevators 138 on the empennage 110, and a rudder 140 on tail 142 of the empennage. Each of the aileron 136, the elevators 138, and the rudder 140 are a hinged control surface that may be used to adjust the pitch, yaw, and roll, respectively, of the aircraft 100. Notwithstanding the fact that in the present embodiment, the aerodynamic system 116 has been described as having a pair of ailerons and elevators, and one rudder (e.g., the aileron 136, the elevators 138, the rudder 140), in at least some embodiments, the number of the ailerons, elevators and rudders may vary. Furthermore, in other embodiments, control surfaces different than, or in addition to, the ones described above, may be used. For example, in some embodiments, elevons, flaperons, spoilers, movable canards, reconfigurable wings, or other types of aerodynamic surfaces may be used instead of or in addition to one or more of the aileron 136, the elevators 138, and the rudder 140.

The ailerons 136, the elevators 138, and the rudder 140 are, in some embodiments, activated after the wings 108 have accumulated sufficient forward airspeed. However, as described further below, in the present disclosure, the aileron 136, the elevators 138, and the rudder 140 may be activated in each flight stage, and at any airspeed, to assist the vertical thrust system 112 in controlling yaw, pitch, and roll during transition from vertical to horizontal motion, and from horizontal to vertical motion.

To actuate, the ailerons 136, the elevators 138, and the rudder 140 are connected to a plurality of servos. For example and as shown, in at least some embodiments, each of the ailerons 136 are connected at least indirectly to its own aileron servo 144, each of the elevators 138 are connected at least indirectly to an elevator servo 146, and the rudder 140 is connected to a rudder servo 148. By virtue of connecting the ailerons 136, the elevators 138, and the rudder 140 to their own servos (e.g., the aileron servo 144, the elevator servo 146, the rudder servo 148), the ailerons, elevators, and the rudder are actuated independently and substantially simultaneously to facilitate flight of the aircraft 100. Nevertheless, in other embodiments, one or more of the aileron, elevators, and rudder may be actuated by commonly shared servos or other actuating devices, so long as the aileron, elevators, and the rudder may be actuated and controlled independently and substantially simultaneously. Furthermore, each of the aileron servo 144, the elevator servo 146, and the rudder servo 148 are connected at least indirectly to a receiver 150 to receive commands therefrom to control the aileron 136, the elevators 138, and the rudder 140, respectively.

As disclosed herein, the aerodynamic system can be used in conjunction with the vertical thrust system to simultaneously control roll, pitch, and yaw moments to aircraft 100 as it gains forward speed. In other words, both the aerodynamic system and the vertical thrust system can be utilized by a pilot or autonomous control system of the aircraft to keep the aircraft 100 stable as it transitions from a vertical flight stage to a horizontal flight stage and from the horizontal flight stage to the vertical flight stage. In particular, independent and substantially simultaneous generation of thrust of the vertical thrust rotors 120 and the horizontal thrust rotor 130, combined with simultaneous and non-independent actuation of the vertical thrust system and the aerodynamic system to control roll, pitch, and yaw of the aircraft 100, facilitates easier and more efficient transition of the aircraft 100 from a vertical motion to a horizontal motion and from the horizontal motion to the vertical motion.

With respect to the main controller 128, it is used to vary the thrust generated by the vertical thrust system 112. Specifically, the main controller 128 is configured to receive input signals for pitch, yaw, and roll from the receiver 150 and further configured to convert those input signals to thrust levels. The main controller 128 then uses these thrust levels to vary the thrust generated by each of the vertical thrust rotors 120, in a manner explained below. To vary the thrust of the vertical thrust rotors 120, in at least some embodiments, the main controller 128 is a part of a flight management system of the aircraft 100. The main controller 128, in other embodiments, may be a stand-alone controller that is in at least indirect communication with the flight management system. Furthermore, the main controller 128 may contain a digital signal processor (DSP), such as, a general-purpose stand alone or embedded processor, or a specialized processing unit suitable for use in the aircraft 100. The main controller 128 may also include multiple processing units connected together at least indirectly and utilized in combination with one another to perform various functions of the main controller.

Additionally, the main controller 128 may be configured to process a variety of program instructions and data, in accordance with the present disclosure. These program instructions and data need not always be digital or composed in any high-level programming language. Rather, the program instructions may be any set of signal-producing or signal-altering circuitry or media that may be capable of performing functions, described in the present disclosure. Furthermore, while the main controller 128 has been shown and described as being located onboard the aircraft 100, in at least some embodiments, the main controller or at least some functionality thereof, may be located at a remote location or on a cloud.

The main controller 128 may also be equipped with a variety of volatile and non-volatile memory/electronic storage, such as, random access memory (RAM), read only memory (ROM), dynamic random access memory (DRAM), programmable read only memory (PROM), erasable programmable read only memory (EPROM), electrically erasable programmable read only memory (EEPROM), flash memory, and the like. In addition to or instead of the above described memory/electronic storage, the main controller 128 could also include storage in the form of optical storage, magnetic storage, cloud storage, computer readable media, or other type of electronic storage capability built into, attachable to, or in connection with the main controller.

The main controller 128 also includes one or more gyro sensors 152, as well as one or more accelerometer sensors 154 to sense rotational motion, changes in orientation of the aircraft 100, or to otherwise sense various parameters relating to the stability of the aircraft. Other sensors that may provide information pertaining to the stability or flight of the aircraft 100 may be used in other embodiments in addition to or instead of the gyro sensors 152 and the accelerometer sensors 154. Based upon the input signals from the receiver 150, as well as the readings of the gyro sensors 152 and the accelerometer sensors 154, the main controller 128 instructs the vertical thrust speed controller 126 to adjust the thrust generated by the vertical thrust rotors 120.

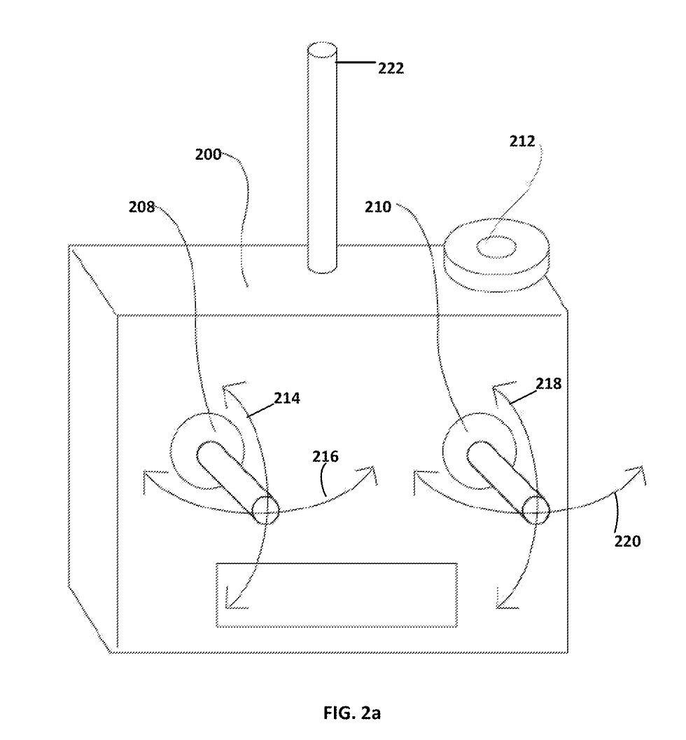

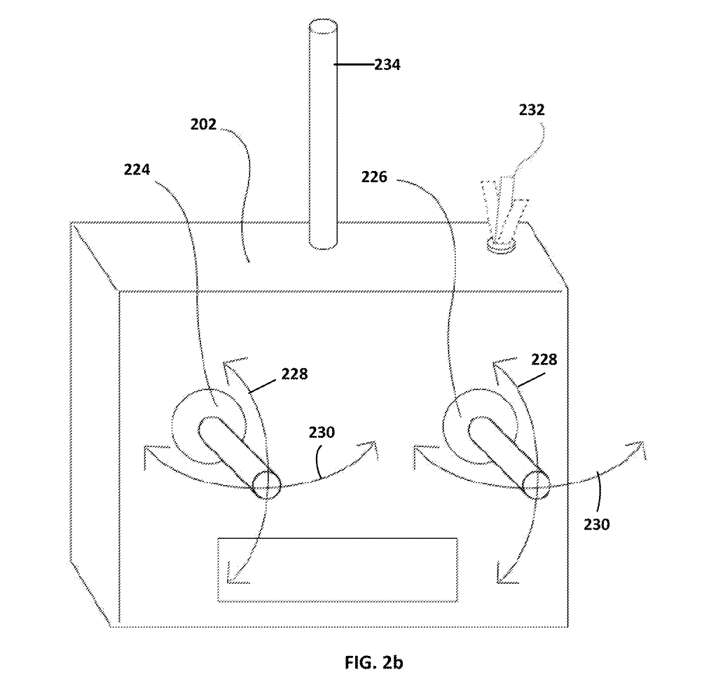

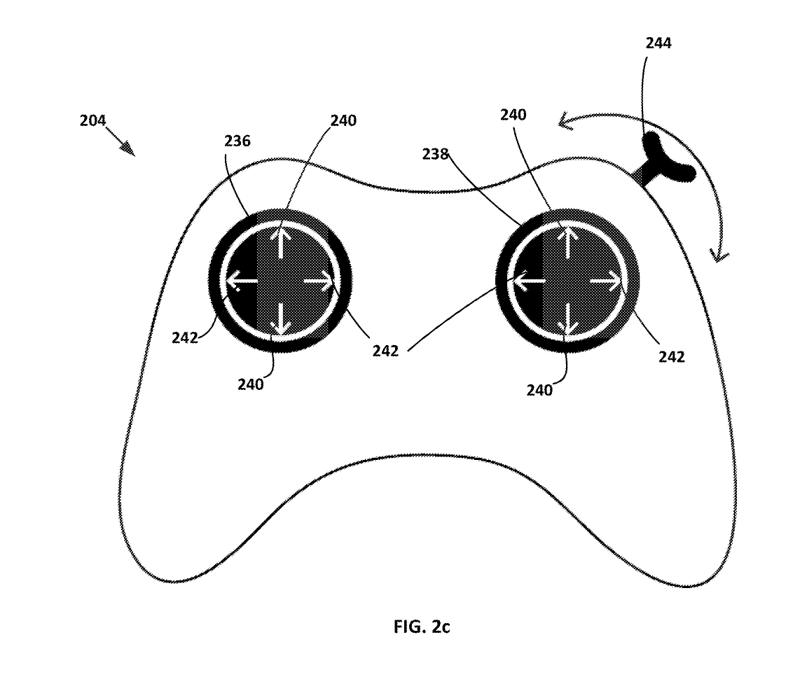

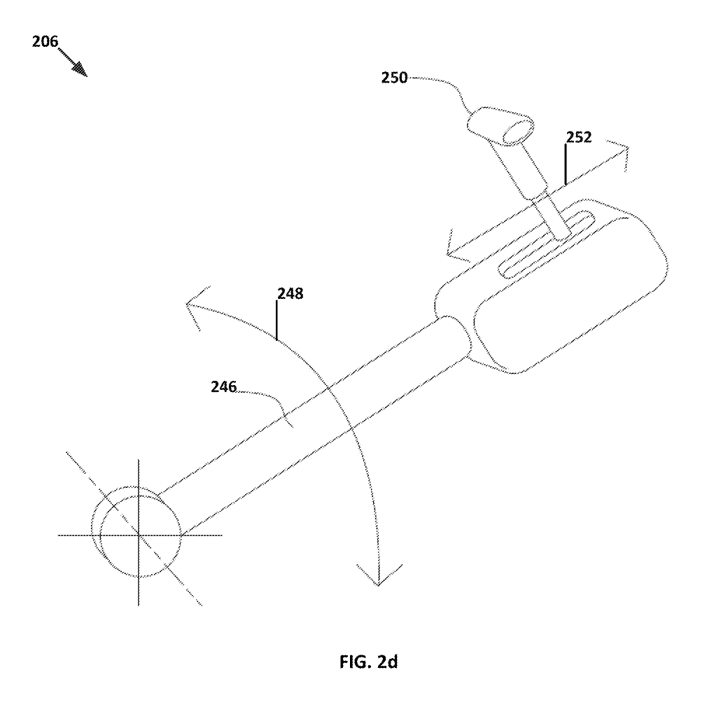

Turning now to FIGS. 2a-d and referring to it in conjunction with FIG. 1, pilot interfaces 200, 202, 204, and 206 are shown, in accordance with at least some embodiments of the present disclosure, particularly embodiments pertaining to remotely piloted aircraft. In particular, the pilot interfaces 200, 202, and 204 are transmitters according to at least some embodiments, and controller 206 is a thrust control for simultaneously and independently controlling vertical and horizontal thrust according to other embodiments. The pilot interfaces 200-206 may be used to provide the input signals to the receiver 150 using radio frequency. In other embodiments, other commonly used mechanisms for aircraft communication may be used to transfer the input signals from the pilot interfaces 200-206 to the receiver 150. In at least some embodiments, the input signals may include signals relating to the pitch, yaw, and roll of the aircraft 100. The input signals may also include signals that may be used to independently and substantially simultaneously vary the thrust generated by the vertical thrust system 112 and the horizontal thrust system 114. In other embodiments, the pilot interfaces 200-206 may be used to control other or different aspects of flight of the aircraft 100 as well.

Furthermore, in at least some embodiments, the pilot interfaces 200-206 may be remotely situated to provide the input signals to the receiver 150. By virtue of situating the pilot interfaces 200-206 remotely, the flight of the aircraft 100 may be controlled remotely by a pilot using the transmitters. Thus, the aircraft 100 may be operated as an un-manned aircraft. In other embodiments, the pilot interfaces 200-206 may be situated on the aircraft 100, particularly when the aircraft is a manned aircraft having at least one pilot on board. In embodiments involving an onboard pilot, the control signals may be transmitted by wire rather than by radio frequency.

Referring now specifically to FIG. 2a, the pilot interface 200 is a transmitter that includes a first gimbal 208, a second gimbal 210, and a forward thrust control 212, each of which is used by the pilot to provide the input signals to the receiver 150. The first gimbal 208, the second gimbal 210, and the forward thrust control 212 are arranged on the pilot interface 200 to enable the pilot to control the vertical thrust system 112 with one hand and the horizontal thrust system 114 with the other hand, thereby permitting independent operation and ease of use. Furthermore, the arrangement of the controls (e.g., the first gimbal 208, the second gimbal 210, the forward thrust control 212) allows the pilot to concurrently adjust the aerodynamic system 116 and the vertical thrust system 112 also to vary the pitch, roll, and yaw of the aircraft 100. Additionally, although the first gimbal 208 and the second gimbal 210 have been shown and described in the present embodiment as having a certain configuration (e.g., a gimbal configuration), such a configuration is merely one illustrative embodiment. In other embodiments, the configuration of one or both of the first gimbal 208 and the second gimbal 210 may vary or they may be replaced with buttons, trackballs, thumb pads, touchpads, or other common methods of providing directional input. Likewise, although the forward thrust control 212 has been shown and described as having a certain configuration, in other embodiments, the forward throttle gimbal may have other configurations. Relatedly, the position of the first gimbal 208, the second gimbal 210, and the forward thrust control 212 may vary in other embodiments.

In at least some embodiments, the first gimbal 208 is used to control the total thrust generated by the vertical thrust system 112, as well as the yaw of the aircraft 100. Specifically, the first gimbal 208 is actuated about a vertical axis of movement 214 to provide a vertical throttle input (also referred to herein as “main throttle channel”) to the receiver 150. The vertical throttle input may be used to control the vertical thrust system 112 of the aircraft 100. The first gimbal 208 is also actuated along a horizontal axis of movement 216 to provide a yaw input for simultaneously controlling the position (e.g., angle of deflection) of the rudder 140 and also the yaw torque exerted on the aircraft 100 by the vertical thrust system 112, for adjusting the yaw of the aircraft 100. Likewise, the second gimbal 210 is actuated along a vertical axis of movement 218 to provide a pitch input to simultaneously control the elevators 138 and the pitch torque exerted on the aircraft 100 by vertical thrust system 112, for adjusting the pitch of the aircraft 100. The second gimbal 210 may also be actuated along a horizontal axis of movement 220 to provide a roll input to simultaneously control the aileron 136 and the roll torque exerted on the aircraft 100 by the vertical thrust system 112, for adjusting the roll of the aircraft.

The forward thrust control 212, on the other hand, is used to provide a forward throttle input (also referred to herein as “auxiliary throttle channel”) to control the horizontal thrust system 114 of the aircraft 100. In at least some embodiments, the forward thrust control 212 has a knob-like configuration or other type of rotating control configured to be operable using the pilot's fingers or thumb. Additionally, the forward thrust control 212 may be configured to have one or more discrete stops to control the horizontal thrust system 114 incrementally. For example, in some embodiments, each incremental position of the forward thrust control 212 may provide a fifty percent (50%) greater power than a previous stop position. In other embodiments, the forward thrust control 212 may be programmed to have other incremental stops to control the thrust generated by the horizontal thrust system 114.

The pilot interface 200 also includes an antenna 222 to broadcast the input signals from the first gimbal 208, the second gimbal 210, and the forward thrust control 212 to the receiver 150. Other mechanisms to broadcast the inputs may be used in other embodiments. Thus, by virtue of using the first gimbal 208, the second gimbal 210, and the forward thrust control 212, each of the aileron 136, the elevators 138, the rudder 140, as well as the vertical thrust system 112 and the horizontal thrust system 114 are controlled by the pilot.

Turning to FIG. 2b, the pilot interface 202 is shown in accordance with at least some embodiments of the present disclosure. The pilot interface 202 is a transmitter substantially similar to the pilot interface 200. Specifically, like the pilot interface 200, the pilot interface 202 includes a first gimbal 224 and a second gimbal 226. The operation of the first gimbal 224 and the second gimbal 226 is substantially similar to the operation of the first gimbal 208 and the second gimbal 210 of the pilot interface 200.

However, in contrast to the forward thrust control 212 of the pilot interface 200, the forward thrust control 232 of the pilot interface 202, in at least some embodiments, includes a three position switch for controlling the horizontal thrust system 114. The three position switch of the forward thrust control 232 provides another mechanism for the pilot to adjust the horizontal thrust using the horizontal thrust system 114. In at least some embodiments, the three position switch of the forward thrust control 232 is configured such that with each consecutive position of the switch, the thrust generated by the horizontal thrust rotor 130 may be increased (or decreased). In some embodiments and similar to the forward thrust control 212, each incremental position of the three position switch of the forward thrust control 232 may provide a fifty percent (50%) greater power than a previous switch position. In other embodiments, the forward thrust control 232 may be programmed to have other increments of switch positions to vary the thrust generated by the horizontal thrust system 114. In other embodiments, the forward thrust control 232 may be programmed to have a discrete number of increments of switch positions either greater than, or less than, three to vary the thrust generated by the horizontal thrust system 114.

Another illustrative embodiment of a transmitter is the pilot interface 204 of FIG. 2c. The pilot interface 204 is a transmitter configured as a game controller having thumb pads 236 and 238 to provide the input signals similar to the first gimbal 208 and the second gimbal 210 of the pilot interface 200. Instead of moving along the vertical axis of movement 214, 218 of the first gimbal 208 and the second gimbal 210, respectively, the thumb pads 236 and 238 are actuated in an up-down direction 240. Thus, by actuating the thumb pad 236 in the up-down direction 240, the thumb pad is used to adjust the vertical throttle input. Likewise, the thumb pad 238 is actuated in the up-down direction 240 to adjust both the pitch input and the pitch torque exerted on the aircraft 100 by the vertical thrust system 112. Similarly, instead of moving along the horizontal axis of movement 216 and 220 of the first gimbal 208 and the second gimbal 210, respectively, the thumb pads 236 and 238 are actuated in an left-right direction 242. For example, by actuating the thumb pad 236 in the left-right direction 242, the thumb pad adjusts the yaw input. Likewise, the thumb pad 238 is actuated in the left-right direction 242 to adjust the roll input.

The pilot interface 204 also has a forward thrust control 244 to provide the forward throttle input, in a manner similar to that described above with respect to the forward thrust control 212. Like the forward thrust control 212, the forward thrust control 244 is actuated independently of and substantially simultaneously with the thumb pads 236 and 238 to control the vertical thrust system 112 and the horizontal thrust system 114 independently and substantially simultaneously, while also controlling the vertical thrust system 112 and the aerodynamic system 116 substantially simultaneously and non-independently for the purpose of adjusting roll, pitch, and yaw of the aircraft 100. The forward thrust control 244 may also include incremental positions to vary the thrust generated by the horizontal thrust system 114 in increments.

Turning now to FIG. 2d, the pilot interface 206 is shown, in accordance with at least some embodiments of the present disclosure. The pilot interface 206 is a thrust control with an integrated dual throttle having a control lever 246 that rotates about an axis of rotation 248 to adjust the vertical thrust system 112 and a forward thrust control 250 for controlling the horizontal thrust system 114. In at least some embodiments, the forward thrust control 250 is configured like a slider to move along an axis 252 to incrementally adjust the horizontal motion of flight of the aircraft 100. Specifically, in at least some embodiments, when the control lever 246 is pulled up, more power is delivered to the vertical thrust system 112 to enable the aircraft 100 to climb vertically (or substantially vertically). Likewise, in those embodiments, when the control lever 246 is pushed down, less power is delivered to the vertical thrust system 112 to enable the aircraft 100 to descend vertically (or substantially vertically). Relatedly, when the forward thrust control 250 is moved forward, more power is sent to the horizontal thrust system 114, thereby enabling the aircraft 100 to gain horizontal airspeed. When the forward thrust control 250 is moved aft, less power is delivered to the horizontal thrust system 114 to enable the aircraft 100 to lose airspeed.

Further, in at least some embodiments, the forward thrust control 250 is positioned on the pilot interface 206 to be operable using the pilot's thumb or fingers. Thus, the pilot interface 206 permits a pilot to grasp the control lever 246 with one hand to rotate it about the axis of rotation 248 to adjust the thrust from the vertical thrust system 112, while simultaneously and independently using the fingers or thumb of the pilot's same hand to adjust the horizontal thrust of the horizontal thrust system 114 using the forward thrust control 250. Additionally, in at least some embodiments, the pilot interface 206 may be situated within the aircraft 100 and used by a pilot on board the aircraft. In some embodiments, the pilot interface 206 may be located on the left side of the pilot's seat, and may be operated with the left hand of the pilot. In other embodiments, the pilot interface 206 may be located on the pilot's right side, or used remotely like the pilot interfaces 200-204, when used in conjunction with other flight controls to adjust pitch, yaw, and roll. Furthermore, when the pilot interface 206 is located within the aircraft 100, a transmitter may be used concurrently with controls within the aircraft that control the pitch, yaw, and roll of the aircraft.

Therefore, each of the pilot interfaces 200-206 receives input signals from a pilot and broadcasts those input signals to the receiver 150 for adjusting flight of the aircraft 100. The pilot interfaces 200-206 discussed above are illustrative embodiments. Other types of transmitters may be used in other embodiments, and various variations and changes in the pilot interfaces 200-206 are contemplated and considered within the scope of the present disclosure. For example, the configuration of the various gimbals and controls may vary in other embodiments. Similarly, the incremental adjustments to adjust the thrust from the horizontal thrust system 114 may vary as well. The shape and size of the pilot interfaces, the direction of actuation, as well as the controls and whether the pilot interfaces are located on board the aircraft 100 or in a remote location may vary from one embodiment to another. Also, the mechanism to broadcast the data from the pilot interfaces 200-206 may vary between embodiments.

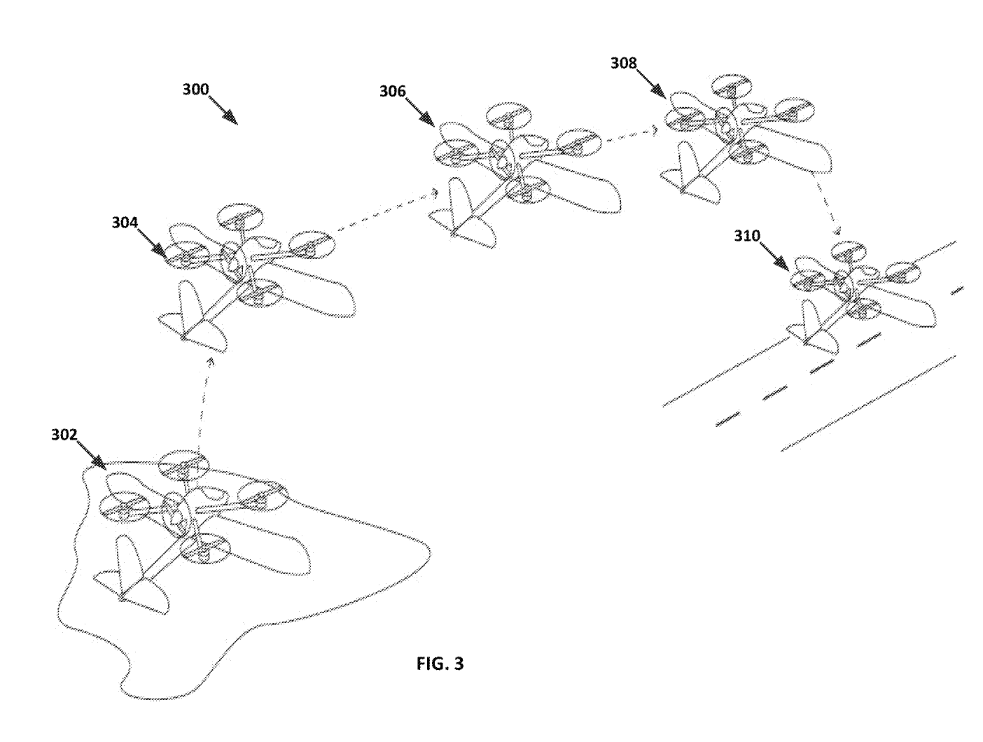

Turning now to FIG. 3, flight stages 300 of the aircraft 100 are shown, in accordance with at least some embodiments of the present disclosure. A first flight stage of the aircraft 100 includes a vertical takeoff stage 302 in which the aircraft takes-off from ground in a vertical (or substantially vertical) motion (e.g., like a helicopter) instead of accelerating on a runway and then taking off at an angle. Vertical (or substantially vertical) motion may include motion of the aircraft 100 in a direction that is perpendicular or substantially perpendicular to the longitudinal axis 118 of the fuselage 106. During the vertical takeoff stage 302, the aircraft 100 may have low or zero horizontal speed. The vertical thrust system 112 provides the vertical thrust needed by the aircraft 100 to takeoff in the vertical (or substantially vertical) motion. The vertical takeoff stage 302 may also include a hovering stage where the aircraft may not be making a vertical ascent, but is merely hovering around a spot.

A second flight stage of the aircraft 100 includes a vertical-to-horizontal stage 304 in which the aircraft transitions from vertical motion to horizontal motion. The vertical-to-horizontal stage 304 occurs when the aircraft 100 has attained sufficient vertical height and is ready to gain airspeed in a horizontal (or substantially horizontal) direction. During the vertical-to-horizontal stage 304, the aircraft 100 may have some vertical motion, as well as some horizontal motion. Therefore, in the vertical-to-horizontal stage 304, thrust is provided simultaneously by both the vertical thrust system 112 and the horizontal thrust system 114.

After transitioning from the vertical motion to the horizontal motion, the aircraft 100 flies in a third flight stage, known as a horizontal stage 306. In the horizontal stage 306, the aircraft 100 may have horizontal (or substantially horizontal) motion with low or zero vertical motion. Thrust is primarily provided by the horizontal thrust system 114 in the horizontal stage 306 and lift is primarily provided by the wing 108.

Once the aircraft 100 is ready to land, the aircraft enters into a fourth flight stage, known herein as a horizontal-to-vertical stage 308. In this stage, the aircraft 100 transitions from horizontal motion to vertical motion for landing. Also, the aircraft 100 may have some horizontal motion, as well as some vertical motion during the horizontal-to-vertical stage 308. Again, the thrust is provided simultaneously by both the vertical thrust system 112 and the horizontal thrust system 114. A fifth flight stage includes a vertical landing stage 310 in which the aircraft 100 lands vertically (or substantially vertically), for example, like a helicopter, instead of decelerating on a runway. The vertical landing stage 310 may also include a hovering stage. Additionally, thrust is primarily provided by the vertical thrust system 112 in the vertical landing stage 310.

Thus, the aircraft 100 may, at any given time, operate in one of the five flight stages described above. During the transitions between vertical and horizontal flight, and back again, the vertical thrust system 112 and the horizontal thrust system 114 are actuated simultaneously and independently to provide thrust to aircraft 100, while the vertical thrust system 112 is also used in conjunction with aerodynamic system 116 in a simultaneous and non-independent manner to control pitch, yaw, and roll of the aircraft 100. Specifically, during the vertical takeoff stage 302, while control of the aircraft 100 is achieved primarily by varying power through the vertical thrust system 112, the aerodynamic system 116 is actuated simultaneously with the roll, pitch, and yaw moments exerted on aircraft 112 by vertical thrust system 112, in order to provide a smoother and faster transition to the vertical-to-horizontal stage 304 as airflow passes over the aerodynamic system 116 and the aerodynamic system 116 becomes effective.

During the vertical-to-horizontal stage 304; pitch, yaw, and roll control of the aircraft 100 is achieved simultaneously by both the aerodynamic system 116 and differential thrust generated by the vertical thrust system 112. In addition, some horizontal thrust may be provided by the horizontal thrust system 114. As the horizontal speed of the aircraft 100 increases due to increasing power from the horizontal thrust system 114, the effectiveness of the aerodynamic system 116 also increases simultaneously with the amount of lift generated by wing 108 increasing, allowing the vertical thrust commanded from the vertical thrust system 112 to be decreased. In particular, when the aircraft 100 has attained sufficient horizontal speed to generate sufficient lift with the wings 108 in the horizontal stage 306, the horizontal thrust system 114 is adjusted to increase horizontal thrust, while the vertical thrust generated by the vertical thrust system 112 is decreased, and may be reduced to zero.

Likewise, in the horizontal-to-vertical stage 308; pitch, yaw, and roll control of the aircraft 100 is achieved simultaneously by both the aerodynamic system 116 and differential power applied to the vertical thrust system 112. In the horizontal-to-vertical stage 308, the power commanded from the horizontal thrust system 114 is gradually decreased. Thus, as the horizontal speed of the aircraft 100 decreases and the lift generated by wing 108 decreases, the effectiveness of both the horizontal thrust system 114 and the aerodynamic system 116 decreases, requiring an increase in vertical thrust commanded via the vertical thrust system 112 and an increase in the pitch, yaw, and roll moments exerted by the vertical thrust system 112 on the aircraft 100. Finally, during the vertical landing stage 310, control of the aircraft is achieved primarily through the vertical thrust system 112, although the aerodynamic system 116 may remain active.

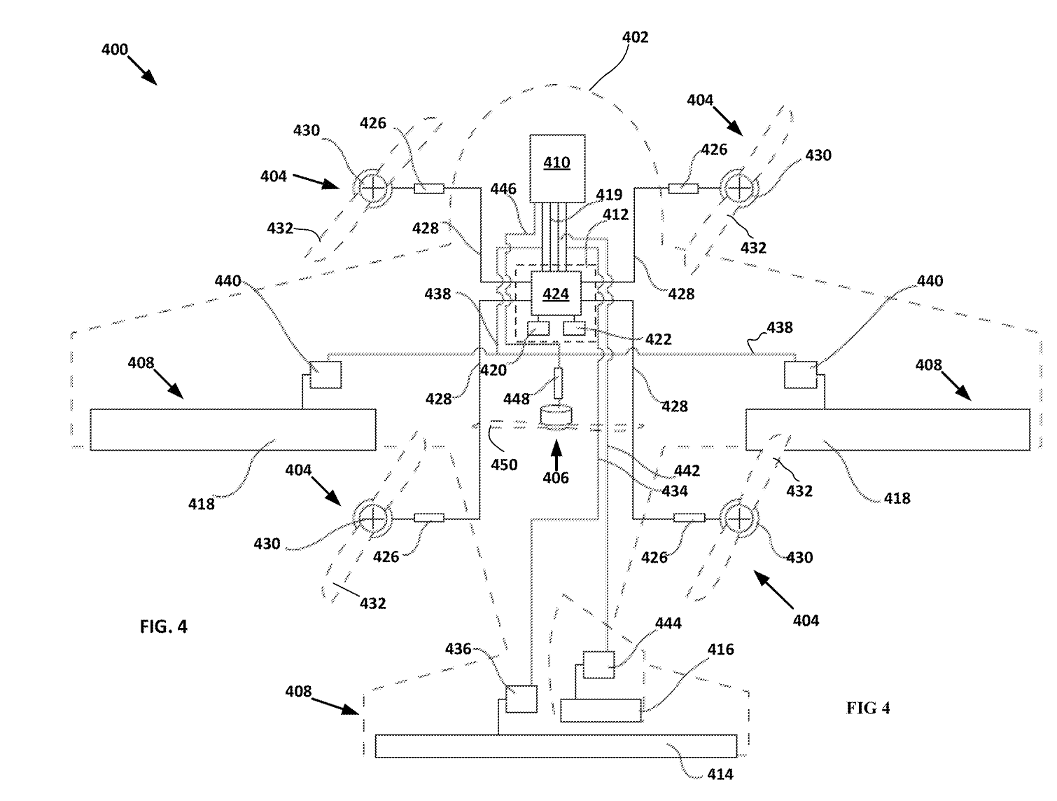

Turning now to FIG. 4, control signals 400 are shown, in accordance with at least some embodiments of the present disclosure, for controlling flight of an aircraft 402 in the flight stages 300 of that aircraft. The control signals 400 shown in FIG. 4 may correspond to, for example components shown in FIG. 1 with respect to the aircraft 100 as discussed above. Similarly, input signals to control a vertical thrust system 404, horizontal thrust system 406, and aerodynamic system 408 may be provided by the pilot interfaces 200-206. The vertical thrust system 404, the horizontal thrust system 406, and the aerodynamic thrust system 408 may, for example, correspond to components of the aircraft 100 discussed above including the vertical thrust system 112, the horizontal thrust system 114, and the aerodynamic system 116, respectively. These input signals are then broadcast from the pilot interfaces 200-206 to receiver 410 on board the aircraft 402. The receiver 410, upon receiving the input signals from the pilot interfaces 200-206, determines the type of the input signals and depending upon the type of the input signals, forwards them to either to a main controller 412, or other components, discussed below. As discussed above with respect to FIGS. 2a-d, the input signals transmitted by the pilot interfaces 200-206 include a vertical throttle input to adjust the vertical thrust commanded from the vertical thrust system 404, a yaw input to adjust the yaw of the aircraft 402, a pitch input to adjust the pitch of the aircraft 402, a roll input to adjust the roll of the aircraft 402, and a forward throttle input to adjust the horizontal thrust commanded from the horizontal thrust system 406. As disclosed herein, the input signals transmitted to adjust the yaw, pitch, and roll of the aircraft 402 may simultaneously activate both the vertical thrust system 404 and the aerodynamic thrust system 408 of the aircraft 402 to enhance maneuverability and controllability of aircraft 402.

Upon receiving the vertical throttle input from the pilot interfaces 200-206, the receiver 410 forwards that input to the main controller 412 via communication link 419. The main controller 412 also receives inputs from gyro sensors 420 and accelerometer sensors 422 for gathering data regarding roll, pitch and yaw of the aircraft 402. The main controller 412 then passes the inputs received from the receiver 410, the gyro sensors 420, and the accelerometer sensors 422 through a computing microchip or processor 424 of the main controller to determine the proper vertical thrust to be commanded from the vertical thrust system 404 in each of the flight stages 300 of the aircraft. The main controller 412 then communicates the desired vertical thrust to one or more vertical thrust speed controllers 426 via communication links 428. The vertical thrust speed controllers 426 alters the speed of vertical thrust motors 430 associated therewith. The vertical thrust motors 430 in turn adjust the torque of vertical thrust rotors 432 with which the vertical thrust motors are associated to vary the vertical thrust generated by the vertical thrust rotors. Thus, the main controller 412 may command a different thrust (e.g., differentiated thrust) from each of the vertical thrust rotors 432 to adjust at least one of pitch, yaw, and roll of the aircraft 402 to adjust the attitude of the aircraft 402 while the vertical thrust system 404 simultaneously propels the aircraft 402 vertically.

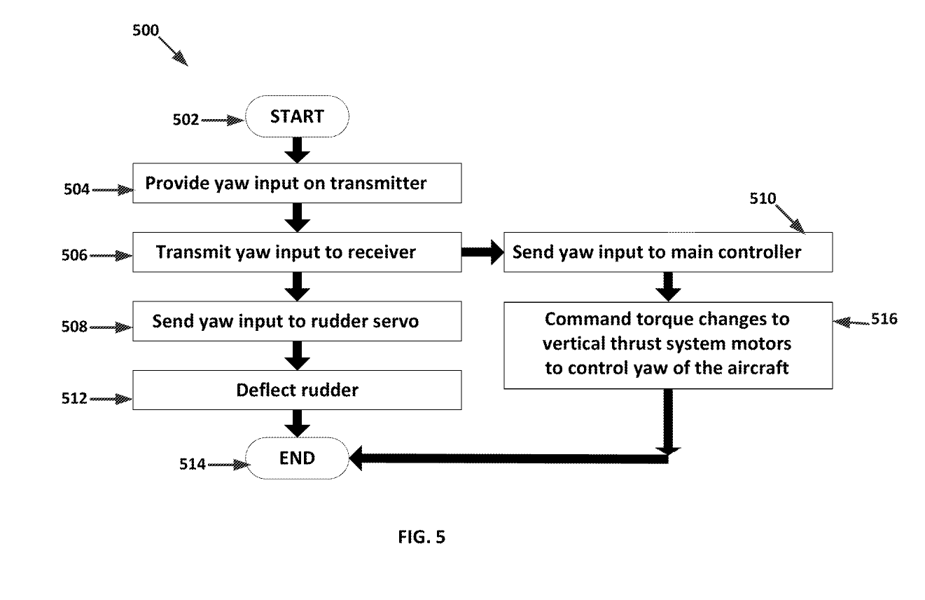

Similarly, the receiver 410 receives a yaw input and transmits that input through communication links 442 (also known herein as “rudder connection split”) to both the main controller 412, as well as rudder servo 444, to simultaneously move the rudder 416 and adjust the torque exerted on the aircraft 402 by the vertical thrust system 404 in the yaw axis. The rudder servo 444 then adjusts the position of the rudder 416, while the main controller 412 communicates with the vertical thrust speed controllers 426 to vary the yaw torque exerted by the vertical thrust rotors 432 on the aircraft 402 in a manner as discussed above. By virtue of adjusting the position of the rudder 416, as well as varying the thrust of the vertical thrust rotors 432, the main controller 412 varies the yaw of the aircraft 402 by using both the vertical thrust system 404 and the aerodynamic system 408 (which includes the rudder 416). Operations for controlling yaw of the aircraft 402 are discussed below with respect to the illustrative embodiment shown in FIG. 5.

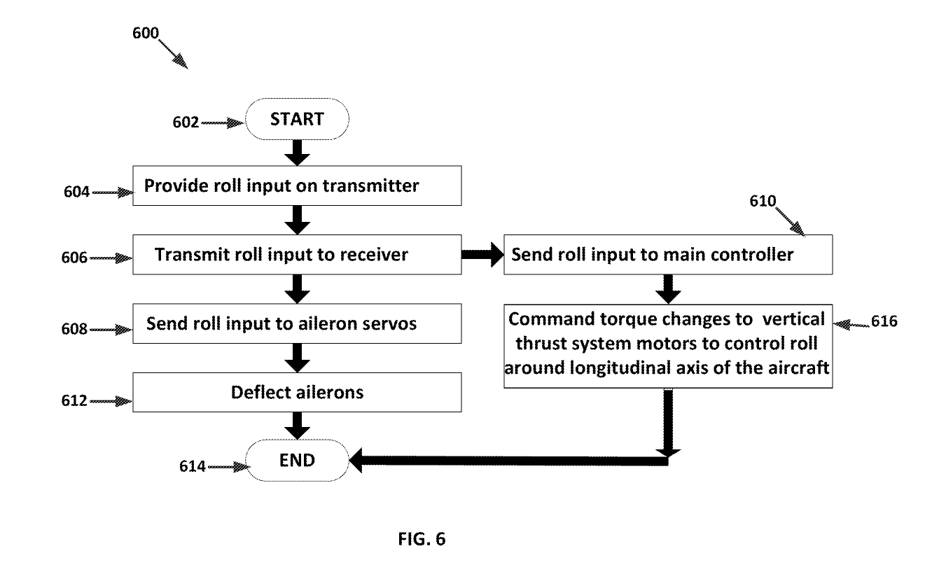

Likewise, roll input received by the receiver 410 are transmitted through communication links 438 (also known herein as “aileron connection split”) to both aileron servos 440 and the main controller 412, to simultaneously move the ailerons 418 and adjust the differential thrust of the vertical thrust rotors 432. By virtue of varying the position of the ailerons 418 and the differential thrust of the vertical thrust rotors 432, the roll of the aircraft 402 is varied. Operations for controlling roll of the aircraft 402 are discussed below with respect to the illustrative embodiment shown in FIG. 6.

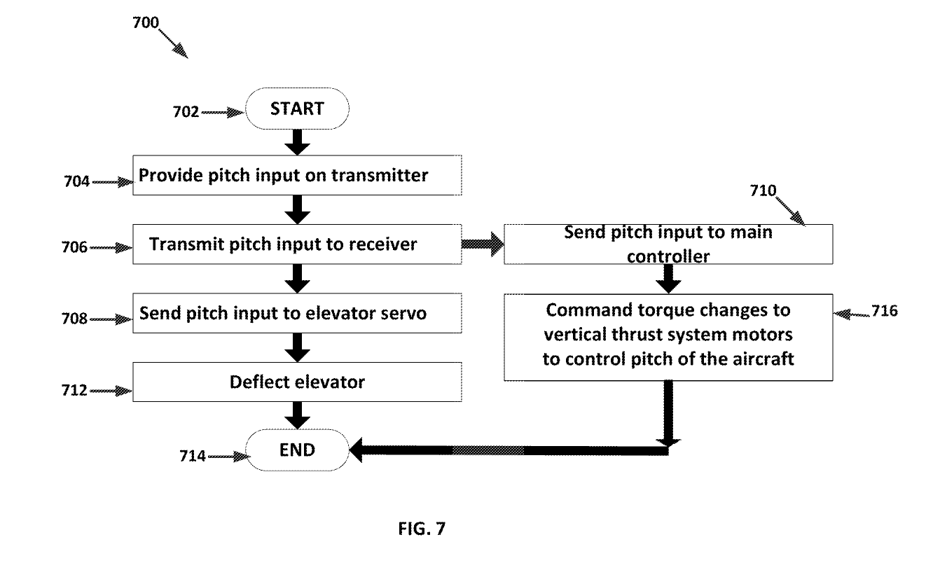

The receiver 410 may forward the pitch input through communication links 434 (also known as “elevator connection split”) to elevator servo 436 and the main controller 412. The elevator servo 436, upon receiving the pitch input, adjusts the position of the elevator 414, while the main controller 412 adjusts the differential thrust of the vertical thrust rotors 432. Thus, the pitch of the aircraft 402 is adjusted. Operations for controlling pitch of the aircraft 402 are discussed below with respect to the illustrative embodiment shown in FIG. 7.

The forward throttle input is transmitted by the receiver 410 via communication links 446 (also known as “forward throttle connection”) to horizontal thrust speed controller 448 to adjust the horizontal thrust generated by horizontal thrust rotor 450.

Thus, the receiver 410 receives input signals from the pilot interfaces 200-206 and depending upon the type of input, directs those input signals to the various servos (e.g., the rudder servo 444, the aileron servos 440, the elevator servo 436) and the main controller 412 to adjust the positions of the rudder 416, the elevators 414, the ailerons 418, as well as to command differentiated thrust and/or torque from each of the vertical thrust rotors 432 of the vertical thrust system 404 to impart pitch, yaw, and roll moments on the aircraft 402.

The vertical thrust system 404 generates thrust that is independent from the thrust generated by the horizontal thrust system 406. This independence of thrust generation, as opposed to other mechanisms of having the same rotor(s)/propeller(s) generating both vertical and horizontal thrust, permits the vertical thrust rotors 432 and the horizontal thrust rotor 450 to be optimized for pitch, twist, taper, revolutions per minute, tip speed, and diameter specific to the speed, thrust requirements, and flight dynamics of vertical and horizontal flight, respectively.

Furthermore, by virtue of controlling the vertical thrust system 404, the horizontal thrust system 406, and the aerodynamic system 408 independently, the receiver 410 and the main controller 412 may effectively and efficiently control attitude and propel the aircraft 402 during any portion of any of the flight stages 300.

Turning now to FIG. 5 and referring to it in conjunction with FIGS. 1 and 2a-d, a flowchart 500 outlining steps for controlling yaw of the aircraft 100, for example, is shown, in accordance with at least some embodiments of the present disclosure. In alternative embodiments, fewer, additional, and/or different steps may be performed. Also, the use of a flow diagram is not meant to be limiting with respect to the order of steps performed. Although the operations with respect to FIG. 5 are referred to with reference to the aircraft 100 of FIG. 1, the operation of FIG. 5 may also be applied to the aircraft 400 shown in FIG. 4 and discussed above. After starting at a step 502, the yaw of the aircraft 100 is controlled by providing a yaw input on the pilot interfaces 200-206 at a step 504. As discussed above, the yaw input is provided on the pilot interface 200 by moving the first gimbal 208 along the horizontal axis of movement 216, on the pilot interface 202 by moving the first gimbal 224 along the horizontal axis of movement 230, or the pilot interface 204 by moving the thumb pad 236 in the left-right direction 242. Other mechanisms for providing the yaw input may be used in other embodiments. The yaw input is then transmitted to the receiver 150 on board the aircraft 100 at a step 506. In at least some embodiments, the yaw input may be transmitted wirelessly to the receiver 150 using radio frequency, infrared, Wi-Fi, or any other commonly used mode of data communication. In other embodiments and particularly when the pilot interfaces 200-206 are located on board the aircraft 100, wired mechanisms may be employed.

Once the receiver 150 receives the yaw input, the receiver then forwards the yaw input to the rudder servo 148 at a step 508, as well as to the main controller 128 at a step 510. In response to the yaw input, the rudder servo 148 deflects the rudder 140 in step 512, causing aircraft 100 to yaw in the desired direction. In at least some embodiments, to yaw the nose of the aircraft 100 to the left, the rudder servo 148 deflects the rudder 140 in a left direction. Likewise, to yaw the nose of the aircraft 100 to a right, the rudder servo 148 deflects the rudder 140 in a right direction. Furthermore, in at least some embodiments, the angle of deflection of the rudder 140 corresponding to a fixed input in horizontal direction 216 on the gimbal 208 of the pilot interface 200 increases as the forward airspeed decreases. Additionally, the controls of the aircraft 100 may be programmed such that aspects of the aerodynamic system (such as the rudder 140) are gradually reduced in sensitivity as the horizontal speed of the aircraft is increased.

In addition to sending the yaw input to the rudder servo 148 at the step 508, the receiver 150 also simultaneously sends the yaw input to the main controller 128 at the step 510. The main controller 128 then adjusts the differential thrust commanded from the vertical thrust system 112 to generate a yaw in the desired direction through differential torque from the motors in vertical thrust system 112. Specifically and as discussed above, in at least some embodiments, the main controller 128 communicates with the vertical thrust speed controllers 126 to instruct the vertical thrust speed controllers to adjust the speed of the vertical thrust rotors 120 associated therewith. The main controller 128 may command a different thrust from each of the vertical thrust rotors 120. The vertical thrust speed controllers 126, upon receiving the commands from the main controller 128, varies the speed of the vertical thrust motors 122 to control the torque exerted on the aircraft 100 by the vertical thrust rotors 120. In at least some embodiments, to yaw the aircraft 100 to the left, the main controller 128 instructs the vertical thrust speed controllers 126 to increase the torque of the vertical thrust rotors 120 that are rotating in a clockwise direction, while decreasing torque to those vertical thrust rotors that are rotating in a counter-clockwise direction. Similarly, in those embodiments, to yaw the aircraft 100 to the right, the main controller 128 instructs the vertical thrust speed controllers 126 to increase the torque of the vertical thrust rotors 120 that are rotating in a counter-clockwise direction and decrease the torque of the rotors that are rotating in a clockwise direction. Once the rudder servo 148 has deflected the rudder 140 and the main controller 128 has adjusted the torque of vertical thrust rotors 120, to achieve the yaw desired by the yaw input, the process ends at a step 514 with the rudder servo 148 and main controller 128 waiting to receive the next yaw input.

After achieving the desired yaw requested via the yaw input, the process ends at the step 514 with the main controller 128 waiting for the next input from the receiver 150.

Turning now to FIG. 6 and referring to it in conjunction with FIGS. 1 and 2a-d, a flowchart 600 outlining steps for controlling roll of the aircraft 100 is shown, in accordance with at least some embodiments of the present disclosure. In alternative embodiments, fewer, additional, and/or different steps may be performed. Also, the use of a flow diagram is not meant to be limiting with respect to the order of steps performed. Although the operations with respect to FIG. 6 are referred to with reference to the aircraft 100 of FIG. 1, the operation of FIG. 6 may also be applied to the aircraft 400 shown in FIG. 4 and discussed above. After starting at a step 602, the roll of the aircraft 100 is controlled by providing an roll input on the pilot interfaces 200-206 at a step 604. As discussed above, the roll input is provided on the pilot interface 200 by moving the second gimbal 210 along the horizontal axis of movement 220, on the pilot interface 202 by moving the second gimbal 226 along the horizontal axis of movement 230, or the pilot interface 204 by moving the thumb pad 238 in the left-right direction 242. Other mechanisms for providing the roll input may be used in other embodiments. The roll input is then transmitted to the receiver 150 on board the aircraft 100 at a step 606 using wired or wireless technology.

Once the receiver 150 receives the roll input, the receiver then forwards the roll input to the aileron servos 144 at a step 608, as well as to the main controller 128 at a step 610. In response to the roll input, the aileron servos 144 deflect the ailerons 136 in step 612 substantially simultaneously with main controller 128 adjusting the thrust of vertical thrust system 112 in step 616. The main controller 128 can adjust the differential thrust commanded on the vertical thrust system 112 simultaneously with deflecting the ailerons 136 until the desired roll of the aircraft 100 commanded by the roll input is reached. In at least some embodiments, to roll the aircraft 100 to the right, the aileron servos 144 deflect an aileron 136 positioned to the left of the center of gravity of the aircraft 100 to a down position and an aileron 136 positioned to the right of the center of gravity of the aircraft 100 to an upward position. By virtue of deflecting the left one of the aileron 136 to the down position and the right one of the ailerons to the up position, the ailerons create a right roll around the longitudinal axis 118 of the aircraft 100. Similarly, in those embodiments, to roll the aircraft 100 to a left side, the aileron servos 144 deflect the left one of the ailerons 136 to an up position and the right one of the ailerons 136 to a down position to create a left roll around the longitudinal axis 118. Furthermore, in at least some embodiments, the angle of deflection of the ailerons 136 corresponding to a fixed roll input on pilot interface 200 is automatically increased as the forward airspeed of the aircraft 100 decreases.

In addition to sending the roll input to the aileron servos 144 at the step 608, the receiver 150 also sends the roll input to the main controller 128 at the step 610. The main controller 128 then adjusts the thrust commanded on the vertical thrust system 112 cause a roll in the desired direction. The main controller 128 communicates with the vertical thrust speed controllers 126, as discussed above, to vary the differential thrust generated by the vertical thrust rotors 120. In at least some embodiments, to roll the aircraft 100 to a right side, the main controller 128 instructs the vertical thrust speed controller 126 to increase the torque (and therefore the thrust) of the vertical thrust rotors 120 (whether rotating in a clockwise direction or a counter-clockwise direction) situated on a left side of the longitudinal axis 118 of the aircraft 100, and decrease the torque of the vertical thrust rotors situated on a right side of the longitudinal axis. Similarly, in those embodiments, to roll the aircraft to a left side, the vertical speed controller 126 decreases the thrust of the vertical thrust rotors 120 on the left side of the longitudinal axis 118, while increasing the thrust of the vertical thrust rotors on the right side of the longitudinal axis.

Once the aileron servos 144 have deflected the ailerons 136 substantially simultaneously with the adjustment of the differential thrust of the vertical thrust rotors 120 to achieve the roll commanded by the roll input, the process ends at a step 614 with the aileron servos 144 and main controller 128 waiting to receive the next roll input.

Turning now to FIG. 7 and referring to it in conjunction with FIGS. 1 and 2a-d, a flowchart 700 outlining steps for controlling pitch of the aircraft 100 is shown, in accordance with at least some embodiments of the present disclosure. In alternative embodiments, fewer, additional, and/or different steps may be performed. Also, the use of a flow diagram is not meant to be limiting with respect to the order of steps performed. Although the operations with respect to FIG. 7 are referred to with reference to the aircraft 100 of FIG. 1, the operation of FIG. 7 may also be applied to the aircraft 400 shown in FIG. 4 and discussed above. After starting at a step 702, the pitch of the aircraft 100 is controlled by providing a pitch input on the pilot interfaces 200-206 at a step 704. As discussed above, the pitch input is provided on the pilot interface 200 by moving the second gimbal 210 along the vertical axis of movement 218, on the pilot interface 202 by moving the second gimbal 226 along the vertical axis of movement 228, or the pilot interface 204 by moving the thumb pad 238 in the up-down direction 240. Other mechanisms for providing the roll input may be used in other embodiments. The pitch input may then be transmitted to the receiver 150 on board the aircraft 100 at a step 706 using wired or wireless technology.

Once the receiver 150 receives the pitch input, the receiver then forwards the pitch input to the elevator servo 146 at a step 708, as well as to the main controller 128 at a step 710. In response to the pitch input at an operation 712, the elevator servo 146 deflects the elevators 138 substantially simultaneously with adjusting the differential thrust from vertical thrust rotors 120 in an operation 716 until the desired pitch of the aircraft 100 indicated by the pitch input is reached. In at least some embodiments, to pitch the nose of the aircraft 100 upwards, the main controller 128 instructs the vertical thrust speed controller 126 to increase the torque (and therefore the thrust) of the vertical thrust rotors 120 (whether rotating in a clockwise direction or a counter-clockwise direction) situated ahead of the center of gravity of the aircraft 100, and decrease the torque of the vertical thrust rotors 120 situated behind the center of gravity. Simultaneously with the adjustments of the thrust of the vertical thrust rotors 120, the elevator servo 146 deflects the elevator 138 in an upwards direction to cause an upward pitching moment on aircraft 100. Similarly, to pitch the nose of the aircraft 100 downwards, the vertical thrust rotors 120 ahead of the center of gravity of the aircraft 100 are controlled to decrease thrust, the vertical thrust rotors 120 behind the center of gravity of the aircraft 100 are controlled to increase thrust, and simultaneously the elevator 138 is deflected in a downward direction to cause a downward pitching moment on the aircraft 100.

In at least some embodiments, once the elevators 138 has been deflected and the differential thrust of vertical thrust rotors 120 have resulted in the desired pitch attitude for aircraft 100 as commanded by the pitch input, the process ends at a step 712 with the elevator servo 146 and main controller 128 waiting to receive the next pitch input.

Although the disclosure herein with respect to FIGS. 5-7 discuss yaw, roll, and pitch inputs that are used to control an aircraft (such as inputs received from the pilot interfaces 200-206), it should be understood that the systems and methods disclosed herein may facilitate simultaneous adjustment of yaw, roll, and pitch of the aircraft with the aerodynamic and vertical thrust systems disclosed herein. In other words, the combined effect of the aerodynamic system and the adjustment of torque/power to the motors of a vertical thrust system causes changes in yaw, roll, and pitch to an aircraft as disclosed herein. Furthermore, such changes in yaw, roll, and pitch to an aircraft can be effected by controls such as those discussed above with respect to the pilot interfaces 200-206 or other pilot interfaces, either on board the aircraft or physically remote form the aircraft. In an alternative embodiment, the controls or inputs cause changes to yaw, roll, or pitch of an aircraft may be received from an autonomous flight system. Accordingly, the yaw input, roll input, and pitch input may all be received simultaneously and cause the aircraft to respond to those inputs simultaneously to control or change the attitude of the aircraft utilizing the aerodynamic and vertical thrust systems of an aircraft.

Thus, the present disclosure provides a mechanism for the aircraft 100 to fly quickly and efficiently in horizontal flight while also possessing the ability to operate efficiently in vertical flight. The aircraft 100 is also capable of easily and controllably transitioning from vertical motion to horizontal motion and also transitioning from horizontal motion to vertical motion are among the most difficult maneuvers for a pilot of a vertical takeoff and landing aircraft. The difficulty may be exacerbated if the aircraft is a remotely controlled aircraft because the pilot does not have the benefit of sensing the movement of the aircraft, and the pilot may have little or no instrumentation provided for airspeed, attitude, and vertical speed. However, by virtue of the present disclosure, the pilot easily and effectively controls the flight of the aircraft even without the advantage of the sense of aircraft movement. Furthermore, the pilot independently and substantially simultaneously controls both the vertical thrust system and the horizontal thrust system. In other words, the pilot interfaces may have a separate and independent control for the throttle/thrust of the horizontal thrust system and the throttle/thrust of the vertical thrust system. The pilot interfaces further may have input mechanisms as described herein that allow the pilot to control any of a yaw, pitch, and roll of an aircraft with the vertical thrust system and the aerodynamic system. However, for controlling the yaw, pitch, and roll of the aircraft, the input from the pilot interface to control those aspects of the aircraft do not separately or independently control the vertical thrust system and the aerodynamic system. Instead, inputs regarding yaw, pitch, and roll may be received at the aircraft from a pilot interface, and the aircraft automatically adjusts, based on the inputs, the yaw, pitch, and/or roll of the aircraft with the vertical thrust system and the aerodynamic system. Accordingly, a pilot may not know or realize whether the vertical thrust system, the aerodynamic system, or both is being used to effect the yaw, pitch, and roll inputs from the pilot interface.

Notwithstanding the embodiments described above, various modifications, changes, and enhancements are contemplated and considered within the scope of the present disclosure. For example and as discussed above, the shape, size, and other configuration of the vertical thrust rotors and the horizontal thrust rotor may vary based upon the size and configuration of the aircraft. Similarly, the components, not described herein, but that may be needed for a proper operation of the main controller, the receiver, as well the pilot interfaces, the vertical thrust system, the horizontal thrust system, and the aerodynamic system may be employed. Further, in at least some embodiments, the main controller may be retrofitted in an existing aircraft and used with the existing components of that aircraft. In another illustrative embodiment, a computer algorithm may be developed to allow safe transition from vertical to horizontal flight modes and from horizontal to vertical flight modes by merely setting a position of a switch or button on the pilot interface.

Additionally, any of the operations described herein may be implemented as computer-readable instructions stored on a non-transitory computer-readable medium such as a computer memory. Accordingly, all such modifications are intended to be included within the scope of the present disclosure. Other substitutions, modifications, changes, and omissions may be made in the design, operating conditions, and arrangement of the preferred and other illustrative embodiments without departing from scope of the present disclosure or from the scope of the appended claims.

It is also to be understood that the construction and arrangement of the elements of the systems and methods as shown in the representative embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed.

Furthermore, functions and procedures described above may be performed by specialized equipment designed to perform the particular functions and procedures. The functions may also be performed by general-use equipment that executes commands related to the functions and procedures, or each function and procedure may be performed by a different piece of equipment with one piece of equipment serving as control or with a separate control device.

Moreover, although the figures show a specific order of method operations, the order of the operations may differ from what is depicted. Also, two or more operations may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection operations, processing operations, comparison operations, and decision operations.

While certain embodiments have been illustrated and described, it should be understood that changes and modifications can be made therein in accordance with ordinary skill in the art without departing from the technology in its broader aspects as defined in the following claims.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An aircraft control system, comprising:
a vertical thrust system having a plurality of vertical thrust rotors, each of the plurality of vertical thrust rotors having an axis of rotation that is substantially perpendicular to a horizontal direction of flight;
a horizontal thrust system having at least one horizontal thrust rotor, the at least one horizontal thrust rotor having an axis of rotation that is substantially parallel to the horizontal direction of flight;
an aerodynamic system having a plurality of movable aerodynamic surfaces; and
a controller in at least indirect communication with the vertical thrust system, the horizontal thrust system, and the aerodynamic system, wherein the controller is configured to:
substantially simultaneously control, based on at least one of a single yaw input, a single pitch input, and a single roll input, the aerodynamic system and a differential thrust generated by the plurality of vertical thrust rotors of the vertical thrust system to adjust at least one of pitch, yaw, and roll of a vertical takeoff and landing aircraft in at least one of a plurality of flight stages of the vertical takeoff and landing aircraft, and
independently and substantially simultaneously control the vertical thrust system and the horizontal thrust system to generate vertical and horizontal thrust in at least one of the plurality of flight stages.

2. The control system of claim 1, wherein one of the plurality of flight stages comprises a first transition flight stage from vertical flight to horizontal flight, and further wherein the controller is configured to independently and substantially simultaneously control the vertical thrust system and the horizontal thrust system to generate vertical and horizontal thrust in the first transition flight stage.

3. The control system of claim 1, wherein the plurality of vertical thrust rotors comprise at least three vertical thrust rotors and the axis of rotation of each of the at least three vertical thrust rotors is separated from remaining ones of the at least three vertical thrust rotors by a distance of at least one quarter of a wingspan of the vertical takeoff and landing aircraft.

4. The control system of claim 1, wherein the plurality of vertical thrust rotors comprise at least three vertical thrust rotors and the axis of rotation of each of the at least three vertical thrust rotors is separated from remaining ones of the at least three vertical thrust rotors by a distance of at least twice a diameter of one of the at least three vertical thrust rotors.

5. The control system of claim 1, wherein each of the plurality of vertical thrust rotors has associated with it a vertical thrust motor and a vertical thrust speed controller.

6. The control system of claim 1, further comprising a receiver located on the vertical takeoff and landing aircraft, the receiver in at least indirect communication with the controller and a pilot interface, wherein the receiver is configured to route input signals received from the pilot interface to the controller.

7. The control system of claim 6, wherein the receiver is configured to route at least some of the input signals received from the pilot interface to the horizontal thrust system.

8. The control system of claim 1, wherein each of the plurality of vertical thrust rotors has fixed pitch blades.

9. The control system of claim 1, wherein the plurality of aerodynamic surfaces comprises at least one rudder, and wherein the controller is further configured to, based on the single yaw input, substantially simultaneously control the vertical thrust system and a position of the at least one rudder to adjust the yaw of the vertical takeoff and landing aircraft.

10. The control system of claim 1, wherein the plurality of aerodynamic surfaces comprises at least one aileron, and wherein the controller is further configured to, based on the single roll input, substantially simultaneously control the vertical thrust system and a position of the at least one aileron to adjust the roll of the vertical takeoff and landing aircraft.

11. The control system of claim 1, wherein the plurality of aerodynamic surfaces comprises at least one elevator, and wherein the controller is further configured to, based on the single pitch input, substantially simultaneously control the vertical thrust system and a position of the at least one elevator to adjust the pitch of the vertical takeoff and landing aircraft.

12. A method for controlling flight of a vertical takeoff and landing aircraft, comprising:
receiving, at a controller located on the vertical takeoff and landing aircraft, input signals comprising a horizontal thrust input, a vertical thrust input, and at least one of a single yaw input, a single pitch input, and a single roll input from a pilot interface, wherein the input signals cause the controller to perform steps comprising:
substantially simultaneously controlling, based on the at least one of the single yaw input, the single pitch input, and the single roll input, an aerodynamic system and a differential thrust generated by a plurality of vertical thrust rotors of a vertical thrust system, wherein the controlling the differential thrust and the aerodynamic system adjusts at least one of pitch, yaw, and roll of the vertical takeoff and landing aircraft in at least one of a plurality of flight stages of the vertical takeoff and landing aircraft; and
independently and substantially simultaneously controlling, based on the horizontal thrust input and the vertical thrust input, the vertical thrust system and a horizontal thrust system to generate vertical and horizontal thrust in at least one of the plurality of flight stages, wherein:
the vertical thrust system comprises the plurality of vertical thrust rotors, wherein each of the plurality of vertical thrust rotors has an axis of rotation that is substantially perpendicular to a horizontal direction of flight,
the horizontal thrust system comprises at least one horizontal thrust rotor, wherein the at least one horizontal thrust rotor has an axis of rotation that is substantially parallel to the horizontal direction of flight, and
the aerodynamic system comprises a plurality of movable aerodynamic surfaces.

13. The method of claim 12, wherein the plurality of flight stages comprises a vertical flight stage and a horizontal flight stage, and wherein during transition from the horizontal flight stage to the vertical flight stage:
a horizontal airspeed of the vertical takeoff and landing aircraft decreases; and
the thrust generated by the plurality of vertical thrust rotors increases.

14. The method of claim 12, wherein the plurality of flight stages comprises a vertical flight stage and a horizontal flight stage, and wherein during transition from the vertical flight stage to the horizontal flight stage:
a horizontal airspeed of the vertical takeoff and landing aircraft increases; and
the thrust generated by the plurality of vertical thrust rotors decreases.

15. The method of claim 12, wherein as the vertical takeoff and landing aircraft transitions from a vertical one of the plurality of flight stages to a horizontal one of the plurality of flight stages, the thrust generated by the horizontal thrust system increases and the thrust generated by the vertical thrust system decreases.

16. The method of claim 12, wherein as the vertical takeoff and landing aircraft transitions from a horizontal one of the plurality of flight stages to a vertical one of the plurality of flight stages, the thrust generated by the horizontal thrust system decreases and the thrust generated by the vertical thrust system increases.

17. A control system to control flight of a vertical takeoff and landing aircraft, comprising:
a receiver located on the vertical takeoff and landing aircraft, the receiver configured to receive input signals input by a pilot into a pilot interface;
a vertical thrust system having a plurality of vertical thrust rotors, each of the plurality of vertical thrust rotors having an axis of rotation that is substantially perpendicular to a horizontal direction of flight;
a horizontal thrust system having at least one horizontal thrust rotor, the at least one horizontal thrust rotor having an axis of rotation that is substantially parallel to the horizontal direction of flight;
an aerodynamic system having a plurality of movable aerodynamic surfaces; and
a controller configured to receive the input signals from the pilot interface via the receiver, wherein the controller is in at least indirect communication with the vertical thrust system, the horizontal thrust system, and the aerodynamic system, wherein
the pilot interface is configured to receive the input signals comprising a horizontal thrust input, a vertical thrust input, a single yaw input, a single pitch input, and a single roll input,
the controller is configured to, based on the input signals, simultaneously control the vertical thrust system and the aerodynamic system to control an attitude of the vertical takeoff and landing aircraft, and
the controller is further configured to, based on the input signals and substantially simultaneously with the control of the attitude, substantially simultaneously adjust the vertical thrust system and the horizontal thrust system, wherein the horizontal thrust input and the vertical thrust input are configured to be input into the pilot interface independently.

18. The control system of claim 17, wherein the pilot interface is physically remote from the vertical takeoff and landing aircraft.

19. The control system of claim 17, wherein the aerodynamic system comprises a rudder, and the controller is further configured to:
transmit the single yaw input to a servo of the rudder, wherein the servo is configured to deflect the rudder to cause a desired direction of yaw of the vertical takeoff and landing aircraft based on the single yaw input; and
substantially simultaneously control the thrust generated by each of the plurality of vertical thrust rotors of the vertical thrust system to cause the vertical takeoff and landing aircraft to yaw in the desired direction.

20. The control system of claim 17, wherein the aerodynamic system comprises at least one aileron, and the controller is further configured to:
transmit the single roll input to a servo of the at least one aileron, wherein the servo is configured to deflect the aileron to cause a desired direction of roll of the vertical takeoff and landing aircraft based on the single roll input; and
substantially simultaneously control the thrust generated by each of the plurality of vertical thrust rotors of the vertical thrust system to cause the vertical takeoff and landing aircraft to roll in the desired direction.
